(19) United States
(12) Patent Application Publication
(10) Pub. No.: US 2026/0189690 A1
(43) Pub. Date: Jul. 2, 2026

(54) ELECTRONIC DEVICE AND NON-TRANSITORY MACHINE-READABLE MEDIUM FOR DECODING AND/OR ENCODING VIDEO DATA

(71) Applicant: SHARP KABUSHIKI KAISHA, Sakai City (JP)

(72) Inventors: YU-CHIAO YANG, New Taipei City (TW); Chih-Yu Teng, New Taipei City (TW)

(21) Appl. No.: 19/432,819

(22) Filed: Dec. 24, 2025

Related U.S. Application Data
(60) Provisional application No. 63/741,229, filed on Jan. 2, 2025.

(51) Int. Cl. H04N 19/105; H04N 19/176; H04N 19/186

(52) U.S. Cl. CPC H04N 19/105; H04N 19/176; H04N 19/186

(57) ABSTRACT

A method of decoding/encoding video data is provided. The method determines a chroma block location of a chroma block unit from an image frame of the video data; a first maximum number N for multiple first cross-component prediction (CCP) merge candidates of the chroma block unit based on a size parameter of the chroma block unit, and a first CCP merge candidate list of the chroma block unit based on the first maximum number N. The method reconstructs the chroma block unit based on the first CCP merge candidate list. The first maximum number N is an integer equal to, or greater than zero, and a number of first CCP merge candidates, included in the first CCP merge candidate list, is equal to the first maximum number N. An electronic device and a non-transitory machine-readable medium of an electronic device using such a method are also provided.

### CROSS-REFERENCE TO RELATED APPLICATION(S)

The present disclosure claims the benefit of and priority to U.S. Provisional Patent Application Ser. No. 63/741,229, filed on Jan. 2, 2025, entitled “ON CANDIDATE LIST SIZE,” the content of which is hereby incorporated herein fully by reference in its entirety for all purposes.

### FIELD

The present disclosure generally relates to video coding, and more specifically, to techniques for predicting and/or reconstructing a chroma block unit based on a cross-component prediction (CCP) merge candidate list of the chroma block unit, the CCP merge candidate list including multiple CCP merge candidates, the number of which is adaptive.

### BACKGROUND

Cross-component prediction (CCP) mode is a chroma coding tool for video coding, in which, an encoder and/or a decoder may predict a chroma block of a current block based on a luma block of the current block by using a prediction model.

In addition, the encoder and/or the decoder may determine the prediction model of the chroma block inherited from one of neighboring blocks generated prior to the reconstruction of the chroma block. The neighboring blocks may have neighboring models. The neighboring models of the neighboring blocks, however, may be just multiple potential models, but not the most appropriate model. Thus, an excessive or insufficient number of neighboring models of the neighboring blocks may be inadequate to precisely and efficiently predict multiple chroma samples in the chroma block.

Thus, quantity adjustment for controlling the number of CCP merge candidates of a chroma block unit may be required for the encoder and/or the decoder to be able to precisely and efficiently predict and/or reconstruct the chroma block of the block unit.

### SUMMARY

The present disclosure is directed to a non-transitory machine-readable medium and an electronic device for predicting and/or reconstructing a chroma block unit based on a cross-component prediction (CCP) merge candidate list, including multiple CCP merge candidates, the number of which is determined based on a size parameter of the chroma block unit.

In a first aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine a chroma block unit of an image frame included in the video data; determine, based on a size parameter of the chroma block unit, a first maximum number for multiple first cross-component prediction (CCP) merge candidates of the chroma block unit, the first maximum number being an integer equal to, or greater than, zero; determine, based on the first maximum number, a first CCP merge candidate list of the chroma block unit, where a number of first CCP merge candidates, included in the first CCP merge candidate list of the chroma block unit, is equal to the first maximum number; and reconstruct the chroma block unit based on the first CCP merge candidate list of the chroma block unit.

In an implementation of the first aspect of the present disclosure, determining the first CCP merge candidate list of the chroma block unit includes: determining, based on a second maximum number, a second CCP merge candidate list of the chroma block unit, where: a number of multiple second CCP merge candidates, included in the second CCP merge candidate list of the chroma block unit, is equal to the second maximum number, and the second maximum number, independent of the size parameter of the chroma block unit, is a predefined integer equal to, or greater than, zero, or equal to, or greater than, the first maximum number; predicting, by using each of the multiple second CCP merge candidates, a chroma template region, neighboring the chroma block unit, to generate a corresponding one of multiple CCP template predictions, the chroma template region including a chroma reconstructed result reconstructed prior to reconstructing the chroma block unit; reordering the multiple second CCP merge candidates by comparing each of the multiple CCP template predictions with the chroma reconstructed result; and determining first N-th ones of the multiple reordered second CCP merge candidates as the multiple first CCP merge candidates, included in the first CCP merge candidate list of the chroma block unit, N being the first maximum number.

In an implementation of the first aspect of the present disclosure, the one or more computer-executable instructions, when executed by the at least one processor of the electronic device, further cause the electronic device to: disable a CCP prediction mode for the chroma block unit when the size parameter of the chroma block unit is equal to, or less than, a predefined threshold; and enable the CCP prediction mode for the chroma block unit, and determine, based on the size parameter of the chroma block unit, the first maximum number of the chroma block unit when the size parameter of the chroma block unit is greater than the predefined threshold.

In an implementation of the first aspect of the present disclosure, the first maximum number of the chroma block unit increases, or remains unchanged, when the size parameter of the chroma block unit increases, and the first maximum number of the chroma block unit decreases, or remains unchanged, when the size parameter of the chroma block unit decreases.

In an implementation of the first aspect of the present disclosure, the first maximum number of the chroma block unit is equal to a first maximum value when the size parameter of the chroma block unit is equal to, or less than, a size value, the first maximum number of the chroma block unit is equal to a second maximum value, and greater than the first maximum value when the size parameter of the chroma block unit is greater than the size value, and the first and second maximum values are positive integers.

In an implementation of the first aspect of the present disclosure, the first maximum number of the chroma block unit is determined based on a maximum table, including multiple table values, and each of multiple size combinations, generated from multiple width candidates and multiple height candidates, corresponds to a specific one of the multiple table values in the maximum table, where determining the first maximum number of the chroma block unit comprises determining the first maximum number of the chroma block unit by comparing the size parameter with the multiple size combinations.

In an implementation of the first aspect of the present disclosure, the one or more computer-executable instructions, when executed by the at least one processor of the electronic device, further cause the electronic device to: determine, from the video data, a high-level syntax element, where the high-level syntax element indicates that: the first maximum number is to be determined based on the size parameter of the chroma block unit, or the first maximum number is to be determined based on another criterion.

In a second aspect of the present disclosure, an electronic device for decoding video data is provided. The electronic device includes at least one processor and at least one non-transitory computer-readable medium that is coupled to the at least one processor. The at least one non-transitory computer-readable medium stores one or more computer-executable instructions that, when executed by the at least one processor, cause the electronic device to: receive the video data; determine a chroma block unit of an image frame included in the video data; determine, based on a size parameter of the chroma block unit, a first maximum number for multiple first cross-component prediction (CCP) merge candidates of the chroma block unit, the first maximum number being an integer equal to, or greater than, zero; determine, based on the first maximum number, a first CCP merge candidate list of the chroma block unit, where a number of first CCP merge candidates, included in the first CCP merge candidate list of the chroma block unit, is equal to the first maximum number; and reconstruct the chroma block unit based on the first CCP merge candidate list of the chroma block unit.

In an implementation of the second aspect of the present disclosure, determining the first CCP merge candidate list of the chroma block unit includes: determining, based on a second maximum number, a second CCP merge candidate list of the chroma block unit, where: a number of multiple second CCP merge candidates, included in the second CCP merge candidate list of the chroma block unit, is equal to the second maximum number, and the second maximum number, independent of the size parameter of the chroma block unit, is a predefined integer equal to, or greater than, zero, or equal to, or greater than, the first maximum number; predicting, by using each of the multiple second CCP merge candidates, a chroma template region, neighboring the chroma block unit, to generate a corresponding one of multiple CCP template predictions, the chroma template region including a chroma reconstructed result reconstructed prior to reconstructing the chroma block unit; reordering the multiple second CCP merge candidates by comparing each of the multiple CCP template predictions with the chroma reconstructed result; and determining first N-th ones of the multiple reordered second CCP merge candidates as the multiple first CCP merge candidates, included in the first CCP merge candidate list of the chroma block unit, N being the first maximum number.

In an implementation of the second aspect of the present disclosure, the one or more computer-executable instructions, when executed by the at least one processor of the electronic device, further cause the electronic device to: disable a CCP prediction mode for the chroma block unit when the size parameter of the chroma block unit is equal to, or less than, a predefined threshold; and enable the CCP prediction mode for the chroma block unit, and determine, based on the size parameter of the chroma block unit, the first maximum number of the chroma block unit when the size parameter of the chroma block unit is greater than the predefined threshold.

In an implementation of the second aspect of the present disclosure, the first maximum number of the chroma block unit increases, or remains unchanged, when the size parameter of the chroma block unit increases, and the first maximum number of the chroma block unit decreases, or remains unchanged, when the size parameter of the chroma block unit decreases.

In an implementation of the second aspect of the present disclosure, the first maximum number of the chroma block unit is equal to a first maximum value when the size parameter of the chroma block unit is equal to, or less than, a size value, the first maximum number of the chroma block unit is equal to a second maximum value, and greater than the first maximum value when the size parameter of the chroma block unit is greater than the size value, and the first and second maximum values are positive integers.

In an implementation of the second aspect of the present disclosure, the first maximum number of the chroma block unit is determined based on a maximum table, including multiple table values, and each of multiple size combinations, generated from multiple width candidates and multiple height candidates, corresponds to a specific one of the multiple table values in the maximum table, where determining the first maximum number of the chroma block unit comprises determining the first maximum number of the chroma block unit by comparing the size parameter with the multiple size combinations.

In an implementation of the second aspect of the present disclosure, the one or more computer-executable instructions, when executed by the at least one processor of the electronic device, further cause the electronic device to: determine, from the video data, a high-level syntax element, where the high-level syntax element indicates that: the first maximum number is to be determined based on the size parameter of the chroma block unit, or the first maximum number is to be determined based on another criterion.

In a third aspect of the present disclosure, an electronic device for encoding video data is provided. The electronic device includes at least one processor and at least one non-transitory computer-readable medium that is coupled to the at least one processor. The at least one non-transitory computer-readable medium stores one or more computer-executable instructions that, when executed by the at least one processor, cause the electronic device to: receive the video data; determine a chroma block unit of an image frame included in the video data; determine, based on a size parameter of the chroma block unit, a first maximum number for multiple first cross-component prediction (CCP) merge candidates of the chroma block unit, the first maximum number being an integer equal to, or greater than, zero; determine, based on the first maximum number, a first CCP merge candidate list of the chroma block unit, where a number of first CCP merge candidates, included in the first CCP merge candidate list of the chroma block unit, is equal to the first maximum number; and reconstruct the chroma block unit based on the first CCP merge candidate list of the chroma block unit.

In an implementation of the third aspect of the present disclosure, determining the first CCP merge candidate list of the chroma block unit includes: determining, based on a second maximum number, a second CCP merge candidate list of the chroma block unit, where: a number of multiple second CCP merge candidates, included in the second CCP merge candidate list of the chroma block unit, is equal to the second maximum number, and the second maximum number, independent of the size parameter of the chroma block unit, is a predefined integer equal to, or greater than, zero, and equal to, or greater than, the first maximum number; predicting, by using each of the multiple second CCP merge candidates, a chroma template region, neighboring the chroma block unit, to generate a corresponding one of multiple CCP template predictions, the chroma template region including a chroma reconstructed result reconstructed prior to reconstructing the chroma block unit; reordering the multiple second CCP merge candidates by comparing each of the multiple CCP template predictions with the chroma reconstructed result; and determining first N-th ones of the multiple reordered second CCP merge candidates as the multiple first CCP merge candidates, included in the first CCP merge candidate list of the chroma block unit, N being the first maximum number.

In an implementation of the third aspect of the present disclosure, the one or more computer-executable instructions, when executed by the at least one processor of the electronic device, further cause the electronic device to: disable a CCP prediction mode for the chroma block unit when the size parameter of the chroma block unit is equal to, or less than, a predefined threshold; and enable the CCP prediction mode for the chroma block unit, and determine, based on the size parameter of the chroma block unit, the first maximum number of the chroma block unit when the size parameter of the chroma block unit is greater than the predefined threshold.

In an implementation of the third aspect of the present disclosure, the first maximum number of the chroma block unit increases, or remains unchanged, when the size parameter of the chroma block unit increases, and the first maximum number of the chroma block unit decreases, or remains unchanged, when the size parameter of the chroma block unit decreases.

In an implementation of the third aspect of the present disclosure, the first maximum number of the chroma block unit is equal to a first maximum value when the size parameter of the chroma block unit is equal to, or less than, a size value, the first maximum number N of the chroma block unit is equal to a second maximum value, and greater than the first maximum value when the size parameter of the chroma block unit is greater than the size value, and the first and second maximum values are positive integers.

In an implementation of the third aspect of the present disclosure, the first maximum number of the chroma block unit is determined based on a maximum table, including multiple table values, and each of multiple size combinations, generated from multiple width candidates and multiple height candidates, corresponds to a specific one of the multiple table values in the maximum table, where determining the first maximum number of the chroma block unit comprises determining the first maximum number of the chroma block unit by comparing the size parameter with the multiple size combinations.

In an implementation of the third aspect of the present disclosure, the one or more computer-executable instructions, when executed by the at least one processor of the electronic device, further cause the electronic device to: determine, from the video data, a high-level syntax element, where the high-level syntax element indicates that: the first maximum number is to be determined based on the size parameter of the chroma block unit, or the first maximum number is to be determined based on another criterion.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIG. 4 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on at least one computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium or a non-transitory machine-readable medium.

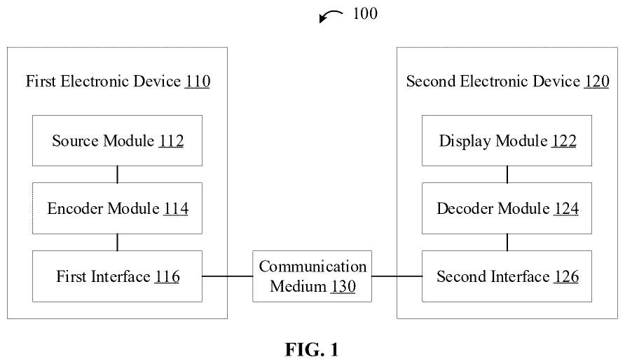

FIG. 1 is a block diagram illustrating a system 100 having a first electronic device and a second electronic device for encoding and decoding video data, in accordance with one or more example implementations of this disclosure.

The system 100 may include a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and/or the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

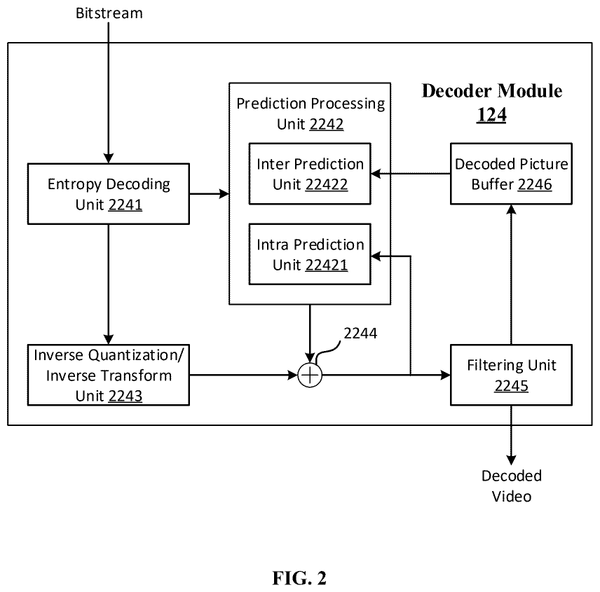

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames based on the partition information.

Each of the image frames may be divided into at least one image block based on the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame, as the current block unit, based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components are reconstructed by using the prediction processing unit 2242.

The intra prediction unit 22421 may reconstruct multiple chroma components of the current block unit based on the multiple luma components of the current block unit when the multiple luma components of the current block unit are reconstructed by using the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (are not explicitly illustrated for brevity of the description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

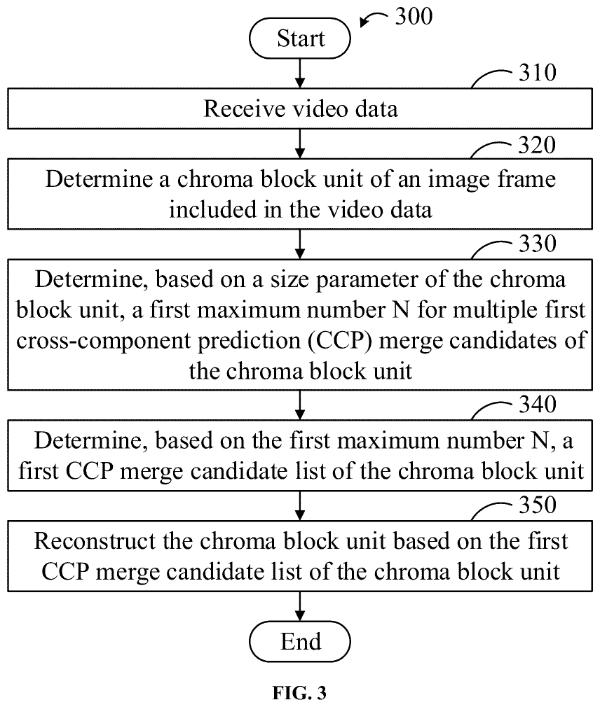

FIG. 3 is a flowchart illustrating a method/process 300 for decoding and/or encoding video data by an electronic device, in accordance with one or more example implementations of this disclosure. The method/process 300 is an example implementation, as there may be a variety of mechanisms of decoding the video data.

The method/process 300 may be performed by an electronic device using the configurations illustrated in FIGS. 1 and/or 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus the order may be different from what is illustrated. Additional blocks may be added or fewer blocks may be utilized without departing from the scope of the present disclosure.

With reference to FIG. 3, at block 310, the method/process 300 may start by receiving (e.g., via the decoder module 124, as shown in FIG. 2) the video data. The video data, received by the decoder module 124, may include a bitstream.

With reference to FIGS. 1 and 2, the second electronic device 120 may receive the bitstream from an encoder, such as the first electronic device 110 (or other video providers), via the second interface 126.

At block 320, the decoder module 124 may determine a chroma block unit of an image frame included in the video data.

With reference to FIGS. 1 and 2, the decoder module 124 may determine the image frames, included in the bitstream, when the video data, received by the decoder module 124, includes the bitstream. The current frame may be one of the image frames, determined based on the bitstream. The decoder module 124 may further divide the current frame to determine the chroma block unit, according to the partition indications in the bitstream. In some implementations, the decoder module 124 may divide the current frame to generate multiple CTUs, and may further divide a current CTU, included in the CTUs, to generate multiple divided blocks and to determine the chroma block unit from the divided blocks, according to the partition indications (e.g., based on any video coding standard).

In some other implementations, the decoder module 124 may divide the current frame to generate multiple slices or multiple tiles, and may further divide a current slice or a current tile, included in the slices or the tiles, to generate multiple CTUs. In addition, the decoder module 124 may further divide a current CTU, included in the CTUs, to generate multiple divided blocks and to determine the chroma block unit from the divided blocks, based on the partition indications. Furthermore, the decoder module 124 may determine a luma collocated block from the current frame. The luma collocated block may be collocated with the chroma block unit, and may be reconstructed prior to the reconstruction of the chroma block unit.

In some implementations, only one luma collocated unit may be collocated with the chroma block unit and determined, as the luma collocated block, when the chroma block unit is included in a single-tree block unit that is determined from the current frame. In some other implementations, at least one luma collocated unit may be covered by the luma collocated block that is collocated with the chroma block unit when the chroma block unit is included in a dual-tree block. The dual-tree block may be determined from the current frame.

The chroma block size Wb×Hb of the chroma block unit may be determined based on a chroma block width Wb and a chroma block height Hb. The luma block size of the luma collocated block may be determined based on the chroma block size of the chroma block unit and a scaling facture SF. The scaling factor SF, including a width scaling factor SubWidthC and a height scaling factor SubHeightC, may be determined based on a video format. Thus, the luma block size of the luma collocated block may be (Wb×SubWidthC)×(Hb×SubHeightC). In some implementations, each of the Wb, Hb, SubWidthC, and SubHeightC may be a positive integer (e.g., one, two, etc.) that may be the same as, or different from, the other ones.

In some implementations, if the video format is YUV422, the scaling factor may further include the width scaling factor SubWidthC of two and the height scaling factor SubHeightC of one. Thus, the luma block size of the luma collocated block may be 2Wb×Hb. In some other implementations, if the video format is YUV420, the scaling factor may further include the width scaling factor SubWidthC of two and the height scaling factor SubHeightC of two. Thus, the luma block size of the luma collocated block may be 2Wb×2Hb.

In addition, a luma block location of the luma collocated block may be represented by (xCb, yCb) specifying a top-left luma sample of the luma collocated block relative to a top-left luma sample of the current frame. A chroma block location of the chroma block unit may be represented by (xCb/SubWidthC, yCb/SubHeightC) specifying a top-left chroma sample of the chroma block unit relative to a top-left chroma sample of the current frame.

Referring back to FIG. 3, at block 330, the decoder module 124 may determine, based on a size parameter of the chroma block unit, a first maximum number N for multiple first cross-component prediction (CCP) merge candidates of the chroma block unit.

With reference to FIGS. 1 and 2, the decoder module 124 may determine the first maximum number N based on the size parameter of the chroma block unit for restricting the number of first CCP merge candidates of the chroma block unit. In some implementations, the CCP merge candidates of the chroma block unit may be determined based on multiple CCP predefined candidates. The decoder module 124 may determine the first CCP merge candidates of the chroma block unit, each corresponding to one of the CCP predefined candidates, and restrict the number of first CCP merge candidates of the chroma block unit to the first maximum number N.

In some implementations, each of the CCP merge candidates of the chroma block unit may be used to predict and/or reconstruct the chroma block unit by using a CCP prediction model in a CCP prediction mode. In some implementations, when the CCP prediction mode is disabled for the chroma block unit, the decoder module 124 may not determine and may not use the first CCP merge candidates of the chroma block unit to predict and/or reconstruct the chroma block unit. Thus, when the CCP prediction mode is disabled for the chroma block unit, the first maximum number N of the chroma block unit may be inferred, or predefined, to be zero. On the other hand, when the CCP prediction mode is enabled for the chroma block unit, the decoder module 124 may determine the first CCP merge candidates of the chroma block unit for predicting and/or reconstructing the chroma block unit. Thus, when the CCP prediction mode is enabled for the chroma block unit, the decoder module 124 may need to determine the first maximum number N of the chroma block unit for searching the first CCP merge candidates of the chroma block unit to generate a first CCP merge candidate list. In some implementations, the first maximum number N of the chroma block unit may be a positive integer when the CCP prediction mode is enabled for the chroma block unit.

In some implementations, when the size parameter of the chroma block unit is equal to, or less than, a predefined threshold, the CCP prediction mode may be disabled for the chroma block unit. In some other implementations, when the size parameter of the chroma block unit is greater than the predefined threshold, the CCP prediction mode may be enabled for the chroma block unit. Thus, the decoder module 124 may further determine, based on the size parameter of the chroma block unit, the first maximum number N of the chroma block unit.

In some implementations, when the size parameter of the chroma block unit is equal to, or less than, a first predefined threshold, or greater than a second predefined threshold, the CCP prediction mode may be disabled for the chroma block unit. In some other implementations, when the size parameter of the chroma block unit is greater than the first predefined threshold, and equal to, or less than, the second predefined threshold, the CCP prediction mode may be enabled for the chroma block unit. Thus, the decoder module 124 may further determine, based on the size parameter of the chroma block unit, the first maximum number N of the chroma block unit.

The following descriptions, regarding the relationship between the chroma block size Wb×Hb and the first maximum number N, are provided to illustrate this relationship under the condition in which the CCP prediction mode is enabled for the chroma block unit.

In some implementations, the size parameter of the chroma block unit may be generated using at least one of the chroma block width Wb and the chroma block height Hb of the chroma block unit. Thus, the first maximum number N of the chroma block unit may be determined based on at least one of the chroma block width Wb and the chroma block height Hb of the chroma block unit.

In some implementations, the first maximum number N of the chroma block unit may be determined only based on the chroma block width Wb of the chroma block unit when the size parameter of the chroma block unit is the chroma block width Wb of the chroma block unit. In some implementations, the first maximum number N of the chroma block unit may be determined only based on the chroma block height Hb of the chroma block unit when the size parameter of the chroma block unit is the chroma block height Hb of the chroma block unit. In some implementations, the first maximum number N of the chroma block unit may be determined based on a size product Wb×Hb, generated by multiplying the chroma block width Wb by the chroma block height Hb, when the size parameter of the chroma block unit is the size product Wb×Hb.

In some implementations, the first maximum number N of the chroma block unit may be determined based on a size ratio (Wb/Hb), generated by dividing the chroma block width Wb by the chroma block height Hb, when the size parameter of the chroma block unit is the size ratio (Wb/Hb). In some implementations, the first maximum number N of the chroma block unit may be determined based on a size ratio (Hb/Wb), generated by dividing the chroma block height Hb by the chroma block width Wb, when the size parameter of the chroma block unit is the size ratio (Hb/Wb). In some implementations, the first maximum number N of the chroma block unit may be determined based on a size pair (Wb, Hb), including the chroma block width Wb and the chroma block height Hb, when the size parameter of the chroma block unit is the size pair (Wb, Hb).

In some implementations, the first maximum number N of the chroma block unit may increase, or remain unchanged, when the size parameter of the chroma block unit increases. In addition, the first maximum number N of the chroma block unit may decrease, or remain unchanged, when the size parameter of the chroma block unit decreases. In some implementations, when the size parameter is one of the chroma block width Wb, the chroma block height Hb, the size product Wb×Hb, the size ratio (Wb/Hb), and the size ratio (Hb/Wb), the size parameter may be compared with a size value. In some implementations, the first maximum number N of the chroma block unit may be equal to a first maximum value when the size parameter of the chroma block unit is equal to, or less than, the size value. In addition, the first maximum number N of the chroma block unit may be equal to a second maximum value that is greater than the first maximum value when the size parameter of the chroma block unit is greater than the size value. For example, the first maximum number N of the chroma block unit may be equal to eight when the size parameter of the chroma block unit is equal to, or less than, sixteen. In addition, the first maximum number N of the chroma block unit may be equal to twelve when the size parameter of the chroma block unit is greater than sixteen. In some implementations, the first and second maximum values may be positive integers.

In some implementations, the first maximum number N of the chroma block unit may decrease, or remain unchanged, when the size parameter of the chroma block unit increases. In addition, the first maximum number N of the chroma block unit may increase, or remain unchanged, when the size parameter of the chroma block unit decreases. In some implementations, the first maximum number N of the chroma block unit may be equal to a third maximum value when the size parameter of the chroma block unit is equal to, or less than, the size value. In addition, the first maximum number N of the chroma block unit may be equal to a fourth maximum value that is less than the third maximum value when the size parameter of the chroma block unit is greater than the size value. For example, the first maximum number N of the chroma block unit may be equal to twenty-one when the size parameter of the chroma block unit is equal to, or less than, sixteen. In addition, the first maximum number N of the chroma block unit may be equal to twelve when the size parameter of the chroma block unit is greater than sixteen. In some implementations, the third and fourth maximum values may be positive integers.

In some implementations, the decoder module 124 may determine the first maximum number N of the chroma block unit, based on the size parameter of the chroma block unit, by using a maximum table. In some implementations, the maximum table, including multiple table values, may be predefined in the decoder module 124 and the encoder module 114. Each of the table values, in the maximum table, may correspond to one of multiple size combinations, generated from multiple width candidates and one of multiple height candidates. The number of width candidates may be equal to a positive integer, such as five, six, seven, or eight, and the number of height candidates may also be equal to a positive integer, such as five, six, seven, or eight. In addition, each of the size combinations may correspond to one of the table values in the maximum table. When the decoder module 124 determines the first maximum number N of the chroma block unit by comparing the size parameter with the size combinations in the maximum table, the decoder module 124 may compare the size pair (Wb, Hb) with the size combinations.

In some implementations, the CCP prediction mode may be disabled for the chroma block unit when the size pair (Wb, Hb) of the chroma block unit is included in a first group of the size combinations. In some implementations, a first set of the table values corresponding, respectively, to the first group of the size combinations, may be inferred, or predefined, to be equal to a first predefined value that is equal to zero. In some implementations, the CCP prediction mode may be enabled for the chroma block unit when the size pair (Wb, Hb) of the chroma block unit is included in other groups of the size combinations. In some implementations, other sets of the table values, corresponding to other groups of the size combinations, may be preset to values that are different from zero, and may be set depending on the size combinations.

In some implementations, the maximum table may include a second set of table values, and each table value, included in the second set, may be equal to a second predefined value A, which is greater than zero. In some implementations, the maximum table may further include a third set of table values, and each table value, included in the third set, may be equal to a third predefined value that is different from the first and second predefined values. In some implementations, the third predefined value may be A−B, and the number B may be an integer, different from zero and the number A. In some implementations, when the number B is greater than zero, the third predefined value A−B may be less than the second predefined value A. In addition, when the number B is less than zero, the third predefined value A−B may be greater than the second predefined value A.

In some implementations, the maximum table may further include a fourth set of table values, each table value, included in the fourth set, may be equal to a fourth predefined value that is different from the first, second, and the third predefined values. In some implementations, the fourth predefined value may be A−C, and the number C may be an integer, different from zero and the numbers A and B. In some implementations, when the number C is greater than zero, the fourth predefined value A−C may be less than the second predefined value A. In addition, when the number C is less than zero, the fourth predefined value A−C may be greater than the second predefined value A.

In some other implementations, the maximum table may include more than two sets of the table values. Each set of the table values, in some such implementation, may be different from each other. The number of sets of the table values may be equal to three, fourth, five, or six.

Table 1 schematically shows an exemplary implementation, where each of the size combinations, generated from the width candidates and the height candidates, corresponds to one of the table values. In some implementations, the maximum table, as shown in Table 1, may include four sets of the table values. Each set of the table values may be, respectively, equal to one of the first to the fourth predefined values. In addition, the number of width candidates and the number of height candidates, as shown in Table 1, may be equal to eight.

TABLE 1

| The first maximum | | Width | | | | | | | |
|---|---|---|---|---|---|---|---|---|---|
| number N | | W1 | W2 | W3 | W4 | W5 | W6 | W7 | W8 |
| Height | H1 | 0 | 0 | 0 | A − B | A − C | A − C | 0 | 0 |
| | H2 | 0 | 0 | A | A − B | A − B | A − C | 0 | 0 |
| | H3 | 0 | A | A | A − B | A − B | A − B | 0 | 0 |
| | H4 | A − B | A − B | A − B | A − B | A − B | A − B | 0 | 0 |
| | H5 | A − C | A − B | A − B | A − B | A − B | A − B | 0 | 0 |
| | H6 | A − C | A − C | A − B | A − B | A − B | A − B | 0 | 0 |
| | H7 | 0 | 0 | 0 | 0 | 0 | 0 | A − B | 0 |
| | H8 | 0 | 0 | 0 | 0 | 0 | 0 | 0 | 0 |

Table 2 schematically shows an exemplary implementation where each of the size combinations, generated from the width candidates and the height candidates, corresponds to one of the table values. In some implementations, the maximum table, as shown in Table 2, may include four sets of the table values. Each set of the table values may be, respectively, equal to one of the first to the fourth predefined values 0, A, A−3, and A−6. In addition, the number of width candidates and the number of height candidates, as shown in Table 2, may be equal to seven.

TABLE 2

| The first maximum | | Width | | | | | | |
|---|---|---|---|---|---|---|---|---|
| number N | | 2 | 4 | 8 | 16 | 32 | 64 | 128 |
| Height | 2 | 0 | 0 | 0 | A − 3 | A − 6 | 0 | 0 |
| | 4 | 0 | 0 | A | A − 3 | A − 3 | 0 | 0 |
| | 8 | 0 | A | A | A − 3 | A − 3 | 0 | 0 |
| | 16 | A − 3 | A − 3 | A − 3 | A − 3 | A − 3 | 0 | 0 |
| | 32 | A − 6 | A − 3 | A − 3 | A − 3 | A − 3 | 0 | 0 |
| | 64 | 0 | 0 | 0 | 0 | 0 | A − 3 | 0 |
| | 128 | 0 | 0 | 0 | 0 | 0 | 0 | 0 |

Table 3 schematically shows an exemplary implementation where each of the size combinations, generated from the width candidates and the height candidates, corresponds to one of the table values. In some implementations, the maximum table, as shown in Table 3, may include four sets of the table values. Each set of the table values may be, respectively, equal to one of the first to fourth predefined values 0, A, A+3, and A+6. In addition, the number of width candidates and the number of height candidates, as shown in Table 3, may be equal to seven.

TABLE 3

| The first maximum | | Width | | | | | | |
|---|---|---|---|---|---|---|---|---|
| number N | | 2 | 4 | 8 | 16 | 32 | 64 | 128 |
| Height | 2 | 0 | 0 | 0 | A + 3 | A + 6 | 0 | 0 |
| | 4 | 0 | 0 | A | A + 3 | A + 3 | 0 | 0 |
| | 8 | 0 | A | A | A + 3 | A + 3 | 0 | 0 |
| | 16 | A + 3 | A + 3 | A + 3 | A + 3 | A + 3 | 0 | 0 |
| | 32 | A + 6 | A + 3 | A + 3 | A + 3 | A + 3 | 0 | 0 |
| | 64 | 0 | 0 | 0 | 0 | 0 | A + 3 | 0 |
| | 128 | 0 | 0 | 0 | 0 | 0 | 0 | 0 |

In some implementations, as shown in Table 2, the number B, used for determining the third predefined value, may be equal to three, and the number C, used for determining the fourth predefined value, may be equal to six. On the other hand, as shown in Table 3, the number B, used for determining the third predefined value, may be equal to −3, and the number C, used for determining the fourth predefined value, may be equal to −6.

In some implementations, since each of the size combinations may correspond to one of the table values, the table values may be predefined in the table based on any criterion. In some implementations, the CCP prediction mode may be disabled for the chroma block unit when the size pair (Wb, Hb) of the chroma block unit is included in a disabled group of the size combinations. In some implementation, the table values corresponding, respectively, to the disabled group of the size combinations, may be inferred, or predefined, to be zero. In some implementations, the CCP prediction mode may be enabled for the chroma block unit when the size pair (Wb, Hb) of the chroma block unit is included in an enabled group of the size combinations. In some implementations, the table values, corresponding to the enabled group of the size combinations, may be preset to values, different from zero, and may be set depending on the size combinations.

Table 4 schematically shows an exemplary implementation where each of the size combinations, generated from the width candidates and the height candidates, corresponds to one of the table values. In some implementations, the maximum table, as shown in Table 4, may include multiple table values A11-A88. In some implementations, when the size pair (Wb, Hb) of the chroma block unit is included in the disabled group of the size combinations, the table values corresponding, respectively, to the disabled group of the size combinations, may be inferred, or predefined, to be zero. In some implementations, when the size pair (Wb, Hb) of the chroma block unit is included in the enabled group of the size combinations, the table values, corresponding to the enabled group of the size combinations, may be preset to values, different from zero, and may be set depending on the size combinations. In addition, each of the table values, corresponding to the enabled group of the size combinations, may be greater than zero, and may be equal to, or different from, the other table values in the enabled group.

TABLE 4

| The first maximum | | Width | | | | | | | |
|---|---|---|---|---|---|---|---|---|---|
| number N | | W1 | W2 | W3 | W4 | W5 | W6 | W7 | W8 |
| Height | H1 | A11 | A21 | A31 | A41 | A51 | A61 | A71 | A81 |
| | H2 | A12 | A22 | A32 | A42 | A52 | A62 | A72 | A82 |
| | H3 | A13 | A23 | A33 | A43 | A53 | A63 | A73 | A83 |
| | H4 | A14 | A24 | A34 | A44 | A54 | A64 | A74 | A84 |
| | H5 | A15 | A25 | A35 | A45 | A55 | A65 | A75 | A85 |
| | H6 | A16 | A26 | A36 | A46 | A56 | A66 | A76 | A86 |
| | H7 | A17 | A27 | A37 | A47 | A57 | A67 | A77 | A87 |
| | H8 | A18 | A28 | A38 | A48 | A58 | A68 | A78 | A88 |

Referring back to FIG. 3, at block 340, the decoder module 124 may determine, based on the first maximum number N, the first CCP merge candidate list of the chroma block unit. The number of first CCP merge candidates, included in the first CCP merge candidate list of the chroma block unit, may be equal to the first maximum number N.

With reference to FIGS. 1 and 2, in some implementations, before the decoder module 124 determines the first CCP merge candidate list, including the first CCP merge candidates, the decoder module 124 may first determine a second CCP merge candidate list, including multiple second CCP merge candidates. The decoder module 124 may then select the first CCP merge candidates from the second CCP merge candidates to restrict the number of first CCP merge candidates to the first maximum number N.

In some implementations, the decoder module 124 may determine a second maximum number K, used for the second CCP merge candidates. In some implementations, the second maximum number K, used for the second CCP merge candidates, may be predefined in the decoder module 124 and the encoder module 114. In some implementations, the second maximum number K, used for the second CCP merge candidates, may be a positive integer, greater than, or equal to, zero, or may be greater than, or equal to, the first maximum number N, used for the first CCP merge candidates.

In some implementations, the decoder module 124 may determine the second CCP merge candidate list of the chroma block unit based on the second maximum number K. In some implementations, the second CCP merge candidate list of the chroma block unit may include the second CCP merge candidates of the chroma block unit. The number of second CCP merge candidates, included in the second CCP merge candidate list of the chroma block unit, may be equal to the second maximum number K. In some implementations, the second maximum number K may be independent of the size parameter of the chroma block unit.

In some implementations, the second CCP merge candidates of the chroma block unit may be determined based on the CCP predefined candidates. The CCP predefined candidates may include at least one of multiple CCP spatial adjacent candidates, multiple CCP temporal candidates, multiple CCP spatial non-adjacent candidates, multiple CCP history-based candidates, or multiple CCP shifted temporal candidates.

In some implementations, the decoder module 124 may determine whether the CCP spatial adjacent candidates, each corresponding to one of multiple chroma adjacent units, is allowed to be added to the second merge candidate list. In some implementations, when a specific one of the chroma adjacent units, which covers at least one of multiple chroma adjacent positions, is predicted based on the CCP prediction mode, the specific chroma adjacent unit may be determined as one of multiple CCP adjacent units. In addition, a CCP prediction filter of the specific chroma adjacent unit may be determined as one of the second CCP merge candidates. In some implementations, the chroma adjacent positions may be predefined as positions adjacent to the chroma block unit, and the number of chroma adjacent positions may be equal to, or greater than, one (e.g., five). In some implementations, the chroma adjacent units may be adjacent to the chroma block unit.

In some implementations, the decoder module 124 may determine whether the CCP temporal candidates, each corresponding to one of multiple chroma temporal units, is allowed to be added to the second merge candidate list. In some implementations, when a specific one of the chroma temporal units, which covers at least one of multiple chroma temporal positions, is predicted based on the CCP prediction mode, the specific chroma temporal unit may be determined as one of multiple CCP temporal units. In addition, a CCP prediction filter of the specific chroma temporal unit may be determined as one of the second CCP merge candidates. In some implementations, the chroma temporal positions may be determined from multiple reference frames in multiple reference picture lists in an inter prediction mode of the video coding standard. The reference picture lists may include a first reference picture list (L0), including multiple first reference frames, and a second reference picture list (L1), including multiple second reference frames. In some implementations, the chroma temporal positions in the first reference picture list (L0) may be different from the chroma temporal positions in the second reference picture list (L1). In some implementations, the chroma temporal positions may be identical to multiple inter temporal positions in an inter merge mode of the video coding standard. In some implementations, the number of chroma temporal positions may be equal to, or greater than, one.

In some implementations, the decoder module 124 may determine whether the CCP spatial non-adjacent candidates, each corresponding to one of multiple chroma non-adjacent units, is allowed to be added to the second merge candidate list. In some implementations, when a specific one of the chroma non-adjacent units, which covers at least one of multiple chroma non-adjacent positions, is predicted based on the CCP prediction mode, the specific chroma non-adjacent unit may be determined as one of multiple CCP non-adjacent units. In addition, a CCP prediction filter of the specific chroma non-adjacent unit may be determined as one of the second CCP merge candidates. In some implementations, the chroma non-adjacent positions may be predefined as positions that are non-adjacent to the chroma block unit, and the number of chroma non-adjacent positions may be equal to, or greater than, one. In some implementations, the chroma non-adjacent positions may be identical to multiple inter non-adjacent positions in the inter merge mode of the video coding standard. In some implementations, the chroma non-adjacent positions may include the first L ones of the inter non-adjacent positions in the inter merge mode of the video coding standard. In some implementations, the number L may be a positive integer. Thus, the number of chroma non-adjacent positions may be less than, or equal to, the number of inter non-adjacent positions in the inter merge mode of the video coding standard. In some implementations, the chroma non-adjacent units may be non-adjacent to the chroma block unit.

In some implementations, the CCP history-based candidates may include multiple CCP prediction filters in a history-based cross-component linear model (H-CCLM) table. In some implementations, the size of H-CCLM table may be equal to six. When a previously-decoded block unit is decoded by the CCP prediction mode, the CCP prediction filter of the previously-decoded block unit may be stored in the H-CCLM table on a first-in-first-out (FIFO) basis. In some implementations, the H-CCLM table may be reset at the beginning of each CTU row. In some implementations, a CCP prediction filter of the previously-decoded block unit may be determined as one of the second CCP merge candidates.

In some implementations, the decoder module 124 may determine whether the CCP shifted temporal candidates, each corresponding to one of multiple chroma shifted temporal units, is allowed to be added to the second merge candidate list. In some implementations, when a specific one of the chroma shifted temporal units, which covers at least one of multiple chroma shifted temporal positions, is predicted based on the CCP prediction mode, the specific chroma shifted temporal unit may be determined as one of multiple CCP shifted temporal units. In addition, a CCP prediction filter of the specific chroma shifted temporal unit may be determined as one of the second CCP merge candidates. In some implementations, the chroma shifted temporal positions may be determined from the reference frames in the reference picture lists in the inter prediction mode of the video coding standard. In some implementations, the chroma shifted temporal positions may be shifted by a selected motion vector, which is derived from multiple motion vectors of multiple neighboring blocks.

In some implementations, the decoder module 124 may keep determining whether the CCP predefined candidates are reconstructed by using the CCP prediction mode when the number of second CCP merge candidates, added to the second CCP merge candidate list, is still less than the second maximum number K. In some implementations, the decoder module 124 may stop determining whether the CCP predefined candidates are reconstructed by using the CCP prediction mode when the number of added second CCP merge candidates has been equal to the second maximum number K.

In some implementations, however, the number of second CCP merge candidates, added to the second CCP merge candidate list, may be still less than the second maximum number K after the decoder module 124 finishes the checking of the CCP predefined candidates. The decoder module 124 may then select at least one CCP additional merge candidate from multiple CCP default merge candidates to be added to the second CCP merge candidate list until the number of added second CCP merge candidates reaches the second maximum number K. The at least one CCP additional merge candidate may be a portion of the second CCP merge candidates when the number of second CCP merge candidates, determined based on the CCP predefined candidates, is less than the second maximum number K. In some implementations, the CCP default merge candidates may be predefined in the encoder module 114 and the decoder module 124.

In some implementations, the decoder module 124 may determine a chroma template region, neighboring the chroma block unit, in the current frame. The chroma template region may include at least one of a first chroma adjacent region that is located at a left side of the chroma block unit, a second chroma adjacent region that is located above the chroma block unit, a third chroma adjacent region that is located at a top-left side of the chroma block unit, a fourth chroma adjacent region that is located at a bottom-left side of the chroma block unit, and a fifth chroma adjacent region that is located at an above-right side of the chroma block unit. In some implementations, the first to fifth chroma adjacent regions may be reconstructed prior to the reconstruction of the chroma block unit. Thus, the chroma template region may include a chroma reconstructed result of the chroma template region when the chroma block unit is being predicted and/or reconstructed. In some implementations, the size of the chroma template region may be determined based on the chroma block size of the chroma block unit.

The decoder module 124 may predict the chroma template region by using the second CCP merge candidates to generate multiple CCP template predictions. In some implementations, each of the CCP template predictions may be generated by predicting the chroma template region using a corresponding one of the second CCP merge candidates. The decoder module 124 may determine multiple template cost values by comparing each of the CCP template predictions with the chroma reconstructed result of the chroma template region. The difference between each of the CCP template predictions and the chroma reconstructed result of the chroma template region may be calculated using a Mean Squared Error (MSE) calculation. In addition, the difference between each of the CCP template predictions and the chroma reconstructed result of the chroma template region may be calculated using one of a Sum of Squared Error (SSE) calculation, a Mean Absolute Difference (MAD) calculation, a Sum of Absolute Difference (SAD) calculation, a Sum of Absolute Transformed Difference (SATD) calculation, or a mean-removed sum of absolute difference (MR-SAD) calculation.

The decoder module 124 may reorder the second CCP merge candidates by comparing each of the CCP template predictions with the chroma reconstructed result. In some implementations, the decoder module 124 may determine an arrangement of the second CCP merge candidates based on the template cost values of the CCP template predictions. The decoder module 124 may reorder the second CCP merge candidates based on the determined arrangement to generate a CCP reordered list. In some implementations, the second CCP merge candidates may be reordered in an ascending order or a descending order of the template cost values.

In some implementations, the number of second CCP merge candidates in the CCP reordered list may be equal to the number of second CCP merge candidates in the second CCP merge candidate list. The decoder module 124 may then determine the first N-th (N being the first maximum number) ones of the reordered second CCP merge candidates as the first CCP merge candidates, included in the first CCP merge candidate list of the chroma block unit. Thus, the number of first CCP merge candidates, included in the first CCP merge candidate list of the chroma block unit, may be equal to the first maximum number N.

In some implementations, the number of second CCP merge candidates in the CCP reordered list may be equal to, or different from, the first maximum number N. In other words, the decoder module 124 may directly add the first N-th ones of the reordered second CCP merge candidates to the first CCP merge candidate list of the chroma block unit. Thus, the first N-th ones of the reordered second CCP merge candidates may be directly determined as the first CCP merge candidates, and the CCP reorder list may be directly determined as the first CCP merge candidate list.

With reference to FIGS. 1 and 2, in some other implementations, the decoder module 124 may directly determine the first CCP merge candidate list without establishing the second CCP merge candidate list in advance.

In some implementations, the decoder module 124 may determine the first CCP merge candidate list of the chroma block unit based on the first maximum number N. In some implementations, the first CCP merge candidate list of the chroma block unit may include the first CCP merge candidates of the chroma block unit. In addition, the number of first CCP merge candidates may be directly determined based on the size parameter of the chroma block unit.

In some implementations, the first CCP merge candidates of the chroma block unit may be directly determined based on the CCP predefined candidates without determining the second CCP merge candidates. The CCP predefined candidates may include at least one of the CCP spatial adjacent candidates, the CCP temporal candidates, the CCP spatial non-adjacent candidates, the CCP history-based candidates, and the CCP shifted temporal candidates.

In some implementations, the decoder module 124 may keep determining whether the CCP predefined candidates are reconstructed by using the CCP prediction mode when the number of first CCP merge candidates, added to the first CCP merge candidate list, is still less than the first maximum number N. In some implementations, the decoder module 124 may stop determining whether the CCP predefined candidates are reconstructed by using the CCP prediction mode when the number of added first CCP merge candidates has been equal to the first maximum number N.

However, in some implementations, the number of first CCP merge candidates, added to the first CCP merge candidate list, may be still less than the first maximum number N after the decoder module 124 finishes the checking of the CCP predefined candidates. The decoder module 124 may then select at least one CCP additional merge candidate from the CCP default merge candidates to be add to the first CCP merge candidate list until the number of added first CCP merge candidates reaches the first maximum number N. The at least one CCP additional merge candidate may be a portion of the first CCP merge candidates when the number of first CCP merge candidates, determined based on the CCP predefined candidates, are less than the first maximum number N. Thus, the decoder module 124 may then determine the first CCP merge candidates based on the CCP predefined candidates to restrict the number of first CCP merge candidates to the first maximum number N.

Referring back to FIG. 3, at block 350, the decoder module 124 may reconstruct the chroma block unit based on the first CCP merge candidate list of the chroma block unit.

With reference to FIGS. 1 and 2, the decoder module 124 may select a prediction mode from the first CCP merge candidate list of the chroma block unit to reconstruct the chroma block unit. In some implementations, the decoder module 124 may select the prediction mode from the first CCP merge candidate list based on a CCP merge index. Thus, the decoder module 124 may select one of the first CCP merge candidates in the first CCP merge candidate list for predicting the chroma block unit.

In some implementations, the decoder module 124 may determine an inherited CCP filter that corresponds to the selected one of the first CCP merge candidates. The decoder module 124 may then predict the chroma block unit based on multiple luma collocated samples, which are included in the luma collocated block, by using the inherited CCP filter to generate a predicted block.

The decoder module 124 may determine multiple residual components of a residual block from the bitstream for the chroma block unit and may add the residual components to the predicted block to reconstruct the chroma block unit. The decoder module 124 may reconstruct all of the other block units in the image frame to reconstruct the image frame and the video.

In some implementations, an adaptive list size flag, used for the chroma block unit, may be determined from the bitstream for indicating whether the first maximum number N is determined based on the size parameter of the chroma block unit.

In some implementations, when the adaptive list size flag is a high-level syntax element, the adaptive list size flag may be determined from the bitstream prior to the determination of a block-level syntax element of the chroma block unit. The high-level syntax is determined from the video data. In some implementations, the high-level syntax element may be included in one of a video parameter set, a sequence parameter set, and a picture parameter set. In some implementations, the high-level syntax element may indicate that the first maximum number is to be determined based on the size parameter of the chroma block unit, or the first maximum number is to be determined based on another criterion. In other words, the high-level syntax element may indicate that the first maximum number is to be determined based on the size parameter of the chroma block unit, or the first maximum number is independent of the size parameter. For example, the high-level syntax element may indicate that the first maximum number is to be determined based on the size parameter of the chroma block unit, or the first maximum number is to be determined to be equal to a fixed value

In some implementations, when the CCP prediction mode is disabled for the chroma block unit, the first maximum number N of the chroma block unit may be inferred, or predefined, to be zero. Thus, even if the adaptive list size flag has been parsed from the bitstream, it may be unnecessary to determine a flag value of the parsed adaptive list size flag, associated with the chroma block unit. In some implementations, when the CCP prediction mode is enabled for the chroma block unit, the decoder module 124 may, or may not, determine the first maximum number N based on the size parameter of the chroma block unit. Thus, since the adaptive list size flag has been parsed from the bitstream, the decoder module 124 may need to check the flag value of the parsed adaptive list size flag, associated with the chroma block unit.

In some implementations, when the adaptive list size flag is a block-level syntax element, the adaptive list size flag, associated with the chroma block unit, may be determined only for the chroma block unit. In some implementations, when the CCP prediction mode is disabled for the chroma block unit, the first maximum number N of the chroma block unit may be inferred, or predefined, to be zero. Thus, the adaptive list size flag of the chroma block unit may be excluded from the bitstream. In some implementations, when the CCP prediction mode is enabled for the chroma block unit, the decoder module 124 may, or may not, determine the first maximum number N based on the size parameter of the chroma block unit. Thus, the adaptive list size flag of the chroma block unit may be included in the bitstream.

In some implementations, when the adaptive list size flag is equal to a first flag value, such as one, the decoder module 124 may determine the first maximum number N based on the size parameter of the chroma block unit. In some implementations, when the adaptive list size flag is equal to a second flag value, such as zero, the decoder module 124 may determine the first maximum number N based on a default maximum number. In some implementations, the default maximum number may be a positive integer and may be predefined in the encoder module 114 and the decoder module 124.

Referring back to FIG. 3, after reconstructing the chroma block unit (e.g., based on the first CCP merge candidate list of the chroma block unit), the method/process 300 may end.

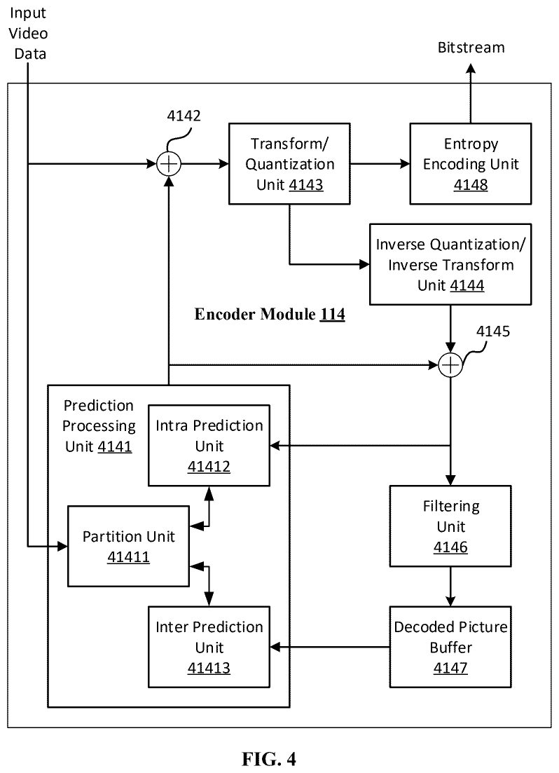

FIG. 4 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 4141), at least a first summer (e.g., a first summer 4142) and a second summer (e.g., a second summer 4145), a transform/quantization processor (e.g., a transform/quantization unit 4143), an inverse quantization/inverse transform n processor (e.g., an inverse quantization/inverse transform unit 4144), a filter (e.g., a filtering unit 4146), a decoded picture buffer (e.g., a decoded picture buffer 4147), and an entropy encoder (e.g., an entropy encoding unit 4148). The prediction processing unit 4141 of the encoder module 114 may further include a partition processor (e.g., a partition unit 41411), an intra prediction processor (e.g., an intra prediction unit 41412), and an inter prediction processor (e.g., an inter prediction unit 41413). The encoder module 114 may receive the source video and encode the source video to output a bitstream.

The encoder module 114 may receive source video including multiple image frames and then divide the image frames based on a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 4141 may receive a current image block of a specific one of the image frames. The current image block may be the luminance block or one of the chrominance blocks in the specific image frame.

The partition unit 41411 may divide the current image block into multiple block units. The intra prediction unit 41412 may perform intra-predictive coding of a current block unit relative to one or more neighboring blocks in the same frame, as the current block unit, in order to provide spatial prediction. The inter prediction unit 41413 may perform inter-predictive coding of the current block unit relative to one or more blocks in one or more reference image blocks to provide temporal prediction.

The prediction processing unit 4141 may select one of the coding results generated by the intra prediction unit 41412 and the inter prediction unit 41413 based on a mode selection method, such as a cost function. The mode selection method may be a rate-distortion optimization (RDO) process.

The prediction processing unit 4141 may determine the selected coding result and provide a predicted block corresponding to the selected coding result to the first summer 4142 for generating a residual block and to the second summer 4145 for reconstructing the encoded block unit. The prediction processing unit 4141 may further provide syntax elements, such as motion vectors, intra-mode indicators, partition information, and/or other syntax information, to the entropy encoding unit 4148.

The intra prediction unit 41412 may intra-predict the current block unit. The intra prediction unit 41412 may determine an intra prediction mode directed toward a reconstructed sample neighboring the current block unit in order to encode the current block unit.

The intra prediction unit 41412 may encode the current block unit using various intra prediction modes. The intra prediction unit 41412 of the prediction processing unit 4141 may select an appropriate intra prediction mode from the selected modes. The intra prediction unit 41412 may encode the current block unit using a cross-component prediction mode to predict one of the two chroma components of the current block unit based on the luma components of the current block unit. The intra prediction unit 41412 may predict a first one of the two chroma components of the current block unit based on the second of the two chroma components of the current block unit.

The inter prediction unit 41413 may inter-predict the current block unit as an alternative to the intra prediction performed by the intra prediction unit 41412. The inter prediction unit 41413 may perform motion estimation to estimate motion of the current block unit for generating a motion vector.

The motion vector may indicate a displacement of the current block unit within the current image block relative to a reference block unit within a reference image block. The inter prediction unit 41413 may receive at least one reference image block stored in the decoded picture buffer 4147 and estimate the motion based on the received reference image blocks to generate the motion vector.

The first summer 4142 may generate the residual block by subtracting the prediction block determined by the prediction processing unit 4141 from the original current block unit. The first summer 4142 may represent the component or components that perform this subtraction.

The transform/quantization unit 4143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 4143 may perform a scan of the matrix including the quantized transform coefficients. Alternatively, the entropy encoding unit 4148 may perform the scan.

The entropy encoding unit 4148 may receive multiple syntax elements from the prediction processing unit 4141 and the transform/quantization unit 4143, including a quantization parameter, transform data, motion vectors, intra modes, partition information, and/or other syntax information. The entropy encoding unit 4148 may encode the syntax elements into the bitstream.

The entropy encoding unit 4148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 4144 may apply inverse quantization and inverse transformation to reconstruct the residual block in the pixel domain for later use as a reference block. The second summer 4145 may add the reconstructed residual block to the prediction block provided by the prediction processing unit 4141 in order to produce a reconstructed block for storage in the decoded picture buffer 4147.

The filtering unit 4146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 4145.

The decoded picture buffer 4147 may be a reference picture memory that stores the reference block to be used by the encoder module 414 to encode video, such as in intra-coding or inter-coding modes. The decoded picture buffer 4147 may include a variety of memory devices, such as DRAM (e.g., including SDRAM), MRAM, RRAM, or other types of memory devices. The decoded picture buffer 4147 may be on-chip with other components of the encoder module 114 or off-chip relative to those components.

The method/process 300 for decoding and/or encoding video data may be performed by the first electronic device 110. With reference to FIGS. 1 and 4, at block 310, the method/process 300 may start by the encoder module 114 receiving the video data. The video data received by the encoder module 114 may be a video.

At block 320, the encoder module 114 may determine a chroma block unit of an image frame included in the video data. With reference to FIGS. 1 and 4, the encoder module 114 may determine the image frames from the video. A current frame may be one of the image frames. The encoder module 114 may further divide the current frame to determine the chroma block unit. In some implementations, the encoder module 114 may divide the current frame to generate multiple CTUs, and may further divide a current CTU, included in the CTUs, to generate multiple divided blocks and to determine the chroma block unit from the divided blocks.

In some implementations, a partitioning structure of the image frame, determined by the encoder module 114, may be identical to a partitioning structure of the image frame, determined by the decoder module 124. Thus, a chroma block location and the chroma block size Wb×Hb of the chroma block unit, determined by the encoder module 114, may be identical to those, determined by the decoder module 124.

At block 330, the encoder module 114 may determine, based on a size parameter of the chroma block unit, a first maximum number N for multiple first cross-component prediction (CCP) merge candidates of the chroma block unit.

With reference to FIGS. 1 and 4, the method and procedure, used by the encoder module 114 for determining the first maximum number N, may be identical to those, used by the decoder module 124. Thus, the relationship between the size parameter and the first maximum number N, determined by the encoder module 114, may be identical to that, determined by the decoder module 124. In addition, the first maximum number N, determined by the encoder module 114, may be identical to that, determined by the decoder module 124.

At block 340, the encoder module 114 may determine, based on the first maximum number N, the first CCP merge candidate list of the chroma block unit.

With reference to FIGS. 1 and 4, the method and procedure, used by the encoder module 114 for determining the first CCP merge candidate list, may be identical to those, used by the decoder module 124. Thus, the first CCP merge candidate list, determined by the encoder module 114, may be identical to that, determined by the decoder module 124. In addition, the first CCP merge candidates, determined by the encoder module 114, may be identical to those, determined by the decoder module 124.

In some implementations, the encoder module 114 may determine the second CCP merge candidates based on the CCP predefined candidates and select the first CCP merge candidates based on the second CCP merge candidates. Thus, the decoder module 124 may also determine the second CCP merge candidates based on the CCP predefined candidates and select the first CCP merge candidates based on the second CCP merge candidates.

In some other implementations, the encoder module 114 may directly determine the first CCP merge candidates based on the CCP predefined candidates without establishing the second CCP merge candidates. Thus, the decoder module 124 may also determine the first CCP merge candidates based on the CCP predefined candidates without establishing the second CCP merge candidates.

Referring back to FIG. 3, at block 350, the encoder module 114 may reconstruct the chroma block unit based on the CCP merge list of the chroma block unit.

With reference to FIGS. 1 and 4, the encoder module 114 may predict the chroma block unit based on each of the first CCP merge candidates to generate multiple predicted blocks. In addition, the encoder module 114 may predict the block unit based on other prediction modes to generate multiple prediction blocks. The encoder module 114 may select one of the predicted blocks and the prediction blocks based on a mode selection method, such as a cost function. The mode selection method may be an RDO process, a Sum of Absolute Difference (SAD) process, a Sum of Absolute Transformed Difference (SATD) process, a Mean Absolute Difference (MAD) process, a Mean Squared Difference (MSD) process, and a Structural SIMilarity (SSIM) process. The encoder module 114 may provide the selected coding result to the first summer 8142 for generating a residual block and to the second summer 8145 for reconstructing the encoded block unit. The reconstruction of the block unit by the encoder module 114 may be identical to the reconstruction of the block unit by the decoder module 124.

In some implementations, when one of the predicted blocks corresponding to one of the first CCP merge candidates is selected to predict and/or reconstruct the chroma block unit, the encoder module 114 may further provide syntax elements, such as a CCP merge index, included in the bitstream for transmitting to the decoder module 124. In some implementations, the CCP merge index of the chroma block unit may be a block-level syntax element, used to determine one CCP merge candidate from the first CCP merge candidates of the chroma block unit.

In some implementations, the syntax elements, encoded in the bitstream by the encoder module 114, may include an adaptive list size flag. The adaptive list size flag may be used for indicating whether the first maximum number N is determined based on the size parameter of the chroma block unit.

In some implementations, when the adaptive list size flag is a high-level syntax element, the adaptive list size flag may be encoded into the bitstream prior to the encoding of a block-level syntax element of the chroma block unit. In some implementations, the high-level syntax element may be included in one of the video parameter set, the sequence parameter set, and the picture parameter set. In some implementations, when the CCP prediction mode is disabled for the chroma block unit, the first maximum number N of the chroma block unit may be inferred, or predefined, to be zero. Thus, even if the adaptive list size flag, associated with the chroma block unit, has been encoded into the bitstream, it may be unnecessary, for the encoder module 114 and the decoder module 124, to consider a flag value of the parsed adaptive list size flag. In some implementations, when the CCP prediction mode is enabled for the chroma block unit, the encoder module 114 may, or may not, determine the first maximum number N based on the size parameter of the chroma block unit. Thus, since the adaptive list size flag has been encoded into the bitstream, the encoder module 124 may need to check the flag value of the parsed adaptive list size flag, associated with the chroma block unit.

Referring back to FIG. 3, after reconstructing the chroma block unit (e.g., based on the first CCP merge candidate list of the chroma block unit), the method/process 300 for the encoder module 114 may then end.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A non-transitory machine-readable medium of an electronic device storing one or more computer-executable instructions for decoding video data, the one or more computer-executable instructions, when executed by at least one processor of the electronic device, causing the electronic device to:
receive the video data;
determine a chroma block unit of an image frame included in the video data;
determine, based on a size parameter of the chroma block unit, a first maximum number for a plurality of first cross-component prediction (CCP) merge candidates of the chroma block unit, the first maximum number being an integer equal to, or greater than, zero;
determine, based on the first maximum number, a first CCP merge candidate list of the chroma block unit, wherein a number of the plurality of first CCP merge candidates, included in the first CCP merge candidate list of the chroma block unit, is equal to the first maximum number; and
reconstruct the chroma block unit based on the first CCP merge candidate list of the chroma block unit.

2. The non-transitory machine-readable medium of claim 1, wherein determining the first CCP merge candidate list of the chroma block unit comprises:
determining, based on a second maximum number, a second CCP merge candidate list of the chroma block unit, wherein:
a number of a plurality of second CCP merge candidates, included in the second CCP merge candidate list of the chroma block unit, is equal to the second maximum number, and
the second maximum number, independent of the size parameter of the chroma block unit, is a predefined integer equal to, or greater than, zero, or equal to, or greater than, the first maximum number;
predicting, by using each of the plurality of second CCP merge candidates, a chroma template region, neighboring the chroma block unit, to generate a corresponding one of a plurality of CCP template predictions, the chroma template region including a chroma reconstructed result reconstructed prior to reconstructing the chroma block unit;
reordering the plurality of second CCP merge candidates by comparing each of the plurality of CCP template predictions with the chroma reconstructed result; and
determining first N-th ones of the plurality of reordered second CCP merge candidates as the plurality of first CCP merge candidates, included in the first CCP merge candidate list of the chroma block unit, N being the first maximum number.

3. The non-transitory machine-readable medium of claim 1, wherein the one or more computer-executable instructions, when executed by the at least one processor of the electronic device, further cause the electronic device to:
disable a CCP prediction mode for the chroma block unit when the size parameter of the chroma block unit is equal to, or less than, a predefined threshold; and
enable the CCP prediction mode for the chroma block unit, and determine, based on the size parameter of the chroma block unit, the first maximum number of the chroma block unit when the size parameter of the chroma block unit is greater than the predefined threshold.

4. The non-transitory machine-readable medium of claim 1, wherein:
the first maximum number of the chroma block unit increases, or remains unchanged, when the size parameter of the chroma block unit increases, and
the first maximum number of the chroma block unit decreases, or remains unchanged, when the size parameter of the chroma block unit decreases.

5. The non-transitory machine-readable medium of claim 4, wherein:
the first maximum number of the chroma block unit is equal to a first maximum value when the size parameter of the chroma block unit is equal to, or less than, a size value,
the first maximum number of the chroma block unit is equal to a second maximum value, and greater than the first maximum value when the size parameter of the chroma block unit is greater than the size value, and
the first and second maximum values are positive integers.

6. The non-transitory machine-readable medium of claim 1, wherein:
the first maximum number of the chroma block unit is determined based on a maximum table, including a plurality of table values, and
each of a plurality of size combinations, generated from a plurality of width candidates and a plurality of height candidates, corresponds to a specific one of the plurality of table values in the maximum table, wherein
determining the first maximum number of the chroma block unit comprises determining the first maximum number of the chroma block unit by comparing the size parameter with the plurality of size combinations.

7. The non-transitory machine-readable medium of claim 1, wherein the one or more computer-executable instructions, when executed by the at least one processor of the electronic device, further cause the electronic device to:
determine, from the video data, a high-level syntax element,
wherein the high-level syntax element indicates that:
the first maximum number is to be determined based on the size parameter of the chroma block unit, or
the first maximum number is to be determined based on another criterion.

8. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a chroma block unit of an image frame included in the video data;
determine, based on a size parameter of the chroma block unit, a first maximum number for a plurality of first cross-component prediction (CCP) merge candidates of the chroma block unit, the first maximum number being an integer equal to, or greater than, zero;
determine, based on the first maximum number, a first CCP merge candidate list of the chroma block unit, wherein a number of the plurality of first CCP merge candidates, included in the first CCP merge candidate list of the chroma block unit, is equal to the first maximum number; and
reconstruct the chroma block unit based on the first CCP merge candidate list of the chroma block unit.

9. The electronic device of claim 8, wherein determining the first CCP merge candidate list of the chroma block unit comprises:
determining, based on a second maximum number, a second CCP merge candidate list of the chroma block unit, wherein:
a number of a plurality of second CCP merge candidates, included in the second CCP merge candidate list of the chroma block unit, is equal to the second maximum number, and
the second maximum number, independent of the size parameter of the chroma block unit, is a predefined integer equal to, or greater than, zero, or equal to, or greater than, the first maximum number;
predicting, by using each of the plurality of second CCP merge candidates, a chroma template region, neighboring the chroma block unit, to generate a corresponding one of a plurality of CCP template predictions, the chroma template region including a chroma reconstructed result reconstructed prior to reconstructing the chroma block unit;
reordering the plurality of second CCP merge candidates by comparing each of the plurality of CCP template predictions with the chroma reconstructed result; and
determining first N-th ones of the plurality of reordered second CCP merge candidates as the plurality of first CCP merge candidates, included in the first CCP merge candidate list of the chroma block unit, N being the first maximum number.

10. The electronic device of claim 8, wherein the one or more computer-executable instructions, when executed by the at least one processor of the electronic device, further cause the electronic device to:
disable a CCP prediction mode for the chroma block unit when the size parameter of the chroma block unit is equal to, or less than, a predefined threshold; and
enable the CCP prediction mode for the chroma block unit, and determine, based on the size parameter of the chroma block unit, the first maximum number of the chroma block unit when the size parameter of the chroma block unit is greater than the predefined threshold.

11. The electronic device of claim 8, wherein:
the first maximum number of the chroma block unit increases, or remains unchanged, when the size parameter of the chroma block unit increases, and
the first maximum number of the chroma block unit decreases, or remains unchanged, when the size parameter of the chroma block unit decreases.

12. The electronic device of claim 11, wherein:
the first maximum number of the chroma block unit is equal to a first maximum value when the size parameter of the chroma block unit is equal to, or less than, a size value, and
the first maximum number of the chroma block unit is equal to a second maximum value, and greater than the first maximum value when the size parameter of the chroma block unit is greater than the size value, and
the first and second maximum values are positive integers.

13. The electronic device of claim 8, wherein:
the first maximum number of the chroma block unit is determined based on a maximum table, including a plurality of table values, and
each of a plurality of size combinations, generated from a plurality of width candidates and a plurality of height candidates, corresponds to a specific one of the plurality of table values in the maximum table, wherein
determining the first maximum number of the chroma block unit comprises determining the first maximum number of the chroma block unit comparing the size parameter with the plurality of size combinations.

14. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a chroma block unit of an image frame included in the video data;
determine, based on a size parameter of the chroma block unit, a first maximum number for a plurality of first cross-component prediction (CCP) merge candidates of the chroma block unit, the first maximum number being an integer equal to, or greater than, zero;
determine, based on the first maximum number, a first CCP merge candidate list of the chroma block unit, wherein a number of the plurality of first CCP merge candidates, included in the first CCP merge candidate list of the chroma block unit, is equal to the first maximum number; and
reconstruct the chroma block unit based on the first CCP merge candidate list of the chroma block unit.

15. The electronic device of claim 14, wherein determining the first CCP merge candidate list of the chroma block unit comprises:
determining, based on a second maximum number, a second CCP merge candidate list of the chroma block unit, wherein:
a number of a plurality of second CCP merge candidates, included in the second CCP merge candidate list of the chroma block unit, is equal to the second maximum number, and
the second maximum number, independent of the size parameter of the chroma block unit, is a predefined integer equal to, or greater than, zero, or equal to, or greater than, the first maximum number;
predicting, by using each of the plurality of second CCP merge candidates, a chroma template region, neighboring the chroma block unit, to generate a corresponding one of a plurality of CCP template predictions, the chroma template region including a chroma reconstructed result reconstructed prior to reconstructing the chroma block unit;
reordering the plurality of second CCP merge candidates by comparing each of the plurality of CCP template predictions with the chroma reconstructed result; and
determining first N-th ones of the plurality of reordered second CCP merge candidates as the plurality of first CCP merge candidates, included in the first CCP merge candidate list of the chroma block unit, N being the first maximum number.

16. The electronic device of claim 14, wherein the one or more computer-executable instructions, when executed by the at least one processor of the electronic device, further cause the electronic device to:
disable a CCP prediction mode for the chroma block unit when the size parameter of the chroma block unit is equal to, or less than, a predefined threshold; and
enable the CCP prediction mode for the chroma block unit, and determine, based on the size parameter of the chroma block unit, the first maximum number of the chroma block unit when the size parameter of the chroma block unit is greater than the predefined threshold.

17. The electronic device of claim 14, wherein:
the first maximum number of the chroma block unit increases, or remains unchanged, when the size parameter of the chroma block unit increases, and
the first maximum number of the chroma block unit decreases, or remains unchanged, when the size parameter of the chroma block unit decreases.

18. The electronic device of claim 17, wherein:
the first maximum number of the chroma block unit is equal to a first maximum value when the size parameter of the chroma block unit is equal to, or less than, a size value, and
the first maximum number of the chroma block unit is equal to a second maximum value, and greater than the first maximum value when the size parameter of the chroma block unit is greater than the size value, and
the first and second maximum values are positive integers.

19. The electronic device of claim 14, wherein:
the first maximum number of the chroma block unit is determined based on a maximum table, including a plurality of table values, and
each of a plurality of size combinations, generated from a plurality of width candidates and a plurality of height candidates, corresponds to a specific one of the plurality of table values in the maximum table, wherein
determining the first maximum number of the chroma block unit comprises determining the first maximum number of the chroma block unit by comparing the size parameter with the plurality of size combinations.

20. The electronic device of claim 14, wherein the one or more computer-executable instructions, when executed by the at least one processor of the electronic device, further cause the electronic device to:
determine, from the video data, a high-level syntax element,
wherein the high-level syntax element indicates that:
the first maximum number is to be determined based on the size parameter of the chroma block unit, or
the first maximum number is to be determined based on another criterion.
